(19) United States
(12) Patent Application Publication
(10) Pub. No.: US 2026/0319121 A1
(43) Pub. Date: Oct. 15, 2026

(54) TEACHING SMALL LANGUAGE MODELS PETRO-TECHNICAL KNOWLEDGE THROUGH LANGUAGE REASONING AND FINE-TUNING

(71) Applicant: Schlumberger Technology Corporation, Sugar Land, TX (US)

(72) Inventors: Mehdi Paydayesh, Crawley (GB); Amir Shamsa, Calgary (CA)

(21) Appl. No.: 19/467,492

(22) Filed: Feb. 2, 2026

Related U.S. Application Data
(60) Provisional application No. 63/751,906, filed on Jan. 31, 2025.

(51) Int. Cl. G01V 1/50; E21B 43/16

(52) U.S. Cl. CPC G01V 1/50; E21B 43/16; E21B 2200/20

(57) ABSTRACT

A method for automatically generating an answer to a petro-technical query in an oil and gas domain includes receiving input data including question-answer pairs related to the oil and gas domain. The method also includes training a small language model (SLM) based upon the input data to produce a trained model. The method also includes fine-tuning the trained model to produce a fine-tuned model. The method also includes receiving the petro-technical query in the oil and gas domain. The method also includes automatically generating the answer to the petro-technical query using the fine-tuned model.

### CROSS-REFERENCE TO RELATED APPLICATIONS

This application claims priority to U.S. Provisional Patent Application No. 63/751,906, filed on Jan. 31, 2025, which is incorporated by reference.

### BACKGROUND

The oil and gas industry relies on sophisticated technical support and efficient customer service operations, often involving complex reasoning and in-depth domain expertise. Large language models (LLMs), such as GPT-4, offer advanced reasoning capabilities, but the cost of using APIs for general-purpose models, such as GPT-4, can be prohibitive for continuous use in industry-specific applications. Additionally, privacy concerns arise when sensitive data, such as operational details or proprietary information, is to be shared with third-party API providers. This creates a barrier to the adoption of LLMs in resource-constrained and security-focused environments.

Thus, there is a growing demand for a local, compact, and high-performance model that can achieve comparable reasoning and task performance to GPT-4 while addressing the privacy concerns and reducing the cost. This compact model should be scalable, maintainable, and tailored specifically to the tasks of the oil and gas industry to ensure both technical effectiveness and operational efficiency.

### Summary

A method for automatically generating an answer to a petro-technical query in an oil and gas domain is disclosed. The method includes receiving input data including question-answer pairs related to the oil and gas domain. The method also includes training a small language model (SLM) based upon the input data to produce a trained model. The method also includes fine-tuning the trained model to produce a fine-tuned model. The method also includes receiving the petro-technical query in the oil and gas domain. The method also includes automatically generating the answer to the petro-technical query using the fine-tuned model.

A computing system is also disclosed. The computing system includes one or more processors and a memory system including one or more non-transitory computer-readable media storing instructions that, when executed by at least one of the one or more processors, cause the computing system to perform operations. The operations include receiving input data. The input data includes question-answer pairs. The question-answer pairs are related to an oil and gas domain. The operations also include training a small language model (SLM) based upon the input data to produce a trained model. The SLM is trained by creating prompts based upon the input data. The prompts include an offer from an artificial intelligence (AI) agent to assist with an issue. The prompts are used to create domain-specific datasets. The domain-specific datasets are distilled from a large language model (LLM). The domain-specific datasets include synthetic data that simulates real-world interactions in the oil and gas domain. The operations also include fine-tuning the trained model to produce a fine-tuned model. Fine-tuning the trained model includes varying a subset of parameters of the trained model. The trained model is fine-tuned using parameter efficient fine-tuning (PEFT) and/or low-rank adaptation (LoRA). The operations also include receiving a petro-technical query in the oil and gas domain. The operations also include automatically generating an answer to the petro-technical query using the fine-tuned model.

A non-transitory computer-readable medium is also disclosed. The medium includes instructions that, when executed by one or more processors of a computing system, cause the computing system to perform operations. The operations include receiving input data. The input data includes question-answer pairs. The question-answer pairs are related to an oil and gas domain. The oil and gas domain is related to seismic interpretation, seismic sampling, seismic volume rendering and extraction, seismic quantitative interpretation, well correlation, facies modelling, petrophysical modelling, discrete fracture modelling, production forecast optimization, trajectory planning, geosteering forward modelling, or well log analysis. The operations also include training a small language model (SLM) based upon the input data to produce a trained model. The SLM is trained by creating prompts based upon the input data. The prompts comprise an offer from an artificial intelligence (AI) agent to assist with a seismic interpretation issue. A tree of thoughts technique is used in the prompts to improve reasoning capabilities of the SLM. The prompts are used to create domain-specific datasets. The domain-specific datasets are distilled from a large language model (LLM). The domain-specific datasets include synthetic data that simulates real-world interactions in the oil and gas domain. The synthetic data includes: (1) one or more synthetic questions about handling large seismic datasets in a software program and (2) one or more synthetic answers from the AI agent. The operations also include fine-tuning the trained model to produce a fine-tuned model. Tine-tuning the trained model includes varying a subset of parameters of the trained model. The trained model is fine-tuned using parameter efficient fine-tuning (PEFT) and low-rank adaptation (LoRA). The operations also include comparing terms used in the trained model, the fine-tuned model, and the LLM. Comparing the terms includes generating graphs for the trained model, the fine-tuned model, and the LLM with a first axis representing a frequency of the terms and a second axis representing an F-score for the terms. The operations also include receiving a petro-technical query in the oil and gas domain. The operations also include automatically generating an answer to the petro-technical query using the fine-tuned model.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a flowchart of a method for automatically generating an answer to a petro-technical query in an oil and gas domain, according to an embodiment.

FIG. 3 illustrates synthetic data (e.g., questions and answers about handling large seismic datasets in a software program), according to an embodiment.

FIG. 4 illustrates results from fine-tuning the trained SLM using PEFT, according to an embodiment.

FIG. 5 illustrates summaries from (1) a LLM, (2) a trained SLM that has not been fine-tuned, and (3) a SLM that has been fine-tuned using PEFT, according to an embodiment.

FIG. 6 illustrates results from fine-tuning the trained SLM using LoRA, according to an embodiment.

FIGS. 7-9 illustrate graphs corresponding to the trained (but non-fine-tuned) SLM (FIG. 7), the trained SLM that has been fine-tuned using LoRA (FIG. 8), and the LLM (FIG. 9), according to an embodiment.

FIG. 10 illustrates a schematic view of a computing system for performing at least a portion of the method(s) described herein, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

### System Overview

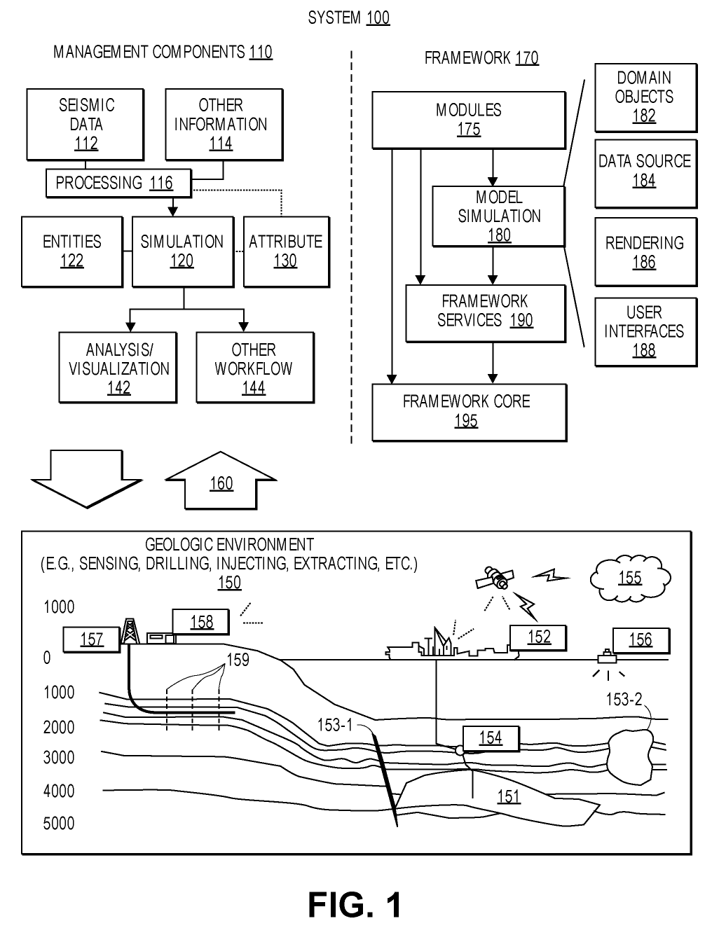

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT^{®} .NET^{®} framework (Redmond, Washington), which provides a set of extensible object classes. In the .NET^{®} framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE^{TM} reservoir simulator (SLB, Houston Texas), the INTERSECT^{TM} reservoir simulator (SLB, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL^{®} seismic to simulation software framework (SLB, Houston, Texas). The PETREL^{®} framework provides components that allow for optimization of exploration and development operations. The PETREL^{®} framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN^{®} framework environment (SLB, Houston, Texas) allows for integration of add-ons (or plug-ins) into a PETREL^{®} framework workflow. The OCEAN^{®} framework environment leverages .NET^{®} tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN^{®} framework where the model simulation layer 180 is the commercially available PETREL^{®} model-centric software package that hosts OCEAN^{®} framework applications. In an example embodiment, the PETREL^{®} software may be considered a data-driven application. The PETREL^{®} software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL^{®} software, for example, that operates on seismic data, seismic attribute(s), etc. As an example, a workflow may be a process implementable in the OCEAN^{®} framework. As an example, a workflow may include one or more worksteps that access a module such as a plug-in (e.g., external executable code, etc.).

### Chat-PTE: Teaching Small Language Models Petro-Technical Knowledge Through Language Reasoning and Fine-Tuning

The present disclosure pertains to the field of artificial intelligence and natural language processing, specifically the development and deployment of small language models (SLMs) fine-tuned for technical knowledge transfer in the oil and gas industry. It relates to optimizing language models for efficient customer service interactions in resource-constrained environments, focusing on complex reasoning and domain-specific applications.

The present disclosure introduces Chat-PTE, a small language model (SLM) designed for the petro-technical industry. The SLM may be fine-tuned using techniques such as low-rank adaptation (LoRA) and the parameter efficient fine-tuning (PEFT) framework, ensuring that it can replicate the reasoning abilities of larger models with reduced computational usage. The creation of Chat-PTE represents an advancement in the deployment of small language models for industry-specific applications. By combining fine-tuning techniques, such as LoRA and PEFT, with the tree of thoughts reasoning approach, this method provides a scalable, efficient solution for improving customer service interactions and technical knowledge dissemination in the oil and gas industry.

The method describe herein may generate synthetic data via prompt engineering and knowledge distillation using the "tree of thoughts" technique to enhance the model's reasoning capabilities. This allows the model to perform highly accurate and complex reasoning tasks in a resource-efficient manner, making it ideal for industry-specific use cases such as seismic interpretation, reservoir analysis, and customer service in the oil and gas sector.

The method described herein may enhance customer service. More particularly, it may improve the quality and accuracy of customer service interactions in the oil and gas industry by deploying an efficient language model tailored to technical queries. The method may also optimize computational resources. More particularly, it may create a language model capable of operating with fewer parameters than conventional large models while maintaining comparable reasoning capabilities. This model may reduce the cost associated with API usage for general-purpose LLMs, enabling scalability in resource-constrained environments. The method may also provide domain-specific customization. More particularly, it may apply fine-tuning techniques to develop a model that can efficiently handle petro-technical terminology, workflows, and processes.

As described above, the SLM may be fine-tuned for industry-specific customer service interactions. It may also be optimized for reduced computational usage using the parameter efficient fine-tuning (PEFT) and low-rank adaptation (LoRA) techniques. Thus, the SLM may be used to perform a method for improving the reasoning capabilities of small language models. The method may generate synthetic data using the "tree of thoughts" technique. The method may also or instead perform knowledge distillation from larger language models for transferring complex reasoning abilities to smaller models. The method may handle technical queries in the oil and gas industry. More particularly, the model may be specifically trained on petro-technical terminology and workflows including, but not limited to, seismic interpretation and data management. The method may be able to fine-tune process small language models. More particularly, prompt engineering techniques may be employed to customize the model's response to domain-specific queries, ensuring high performance in resource-limited environments. The SLM may have a scalable system architecture that integrates the fine-tuned small language model into customer service platforms within the oil and gas industry, allowing for real-time processing of technical queries with low computational demands.

### Phase 1: Synthetic Data Generation and Prompt Engineering

The method may employ the tree of thoughts. This technique may be employed to optimize the reasoning capabilities of the language model. It generates complex reasoning paths, which are distilled into the SLM to enhance its ability to process domain-specific queries effectively. The method may provide knowledge distillation. LLMs like GPT-4 are used to generate synthetic data that is then used to train the SLM. This process transfers the reasoning abilities of the larger models to the smaller model while maintaining computational efficiency. The method may also provide prompt engineering. Carefully designed prompts may be used to create domain-specific datasets that simulate real-world interactions within the oil and gas industry, focusing on areas like seismic interpretation and data management.

### Phase 2: Fine-Tuning via Parameter Efficient Fine-Tuning (PEFT)

The method may use parameter efficient fine-tuning (PEFT). The PEFT techniques allow for fine-tuning specific layers or components of the model, ensuring it remains adaptable to various tasks and queries without requiring significant computational overhead. The method may also use low-rank adaptation (LoRA). As a specific method within the PEFT framework, LoRA may be employed to fine-tune the model with minimal changes to its parameters. This makes the process computationally efficient while maintaining high performance in reasoning tasks, by optimizing certain low-rank matrices within the model's architecture.

### System Architecture

The system that performs the method may include an input-processing module, where customer service queries are received, processed through the fine-tuned SLM, and returned with accurate, context-specific responses. The system integrates into existing customer service platforms, enhancing the ability to handle complex, technical questions efficiently.

### Fine-Tuning Techniques

The fine-tuning process involves retraining selected layers of the model using LoRA and PEFT. LoRA optimizes the model by adjusting certain low-rank matrices within the model's architecture, thereby reducing memory and computational costs. PEFT, on the other hand, adjusts the fine-tuning parameters of the model to ensure high adaptability to various customer service scenarios without sacrificing efficiency.

### Tree of Thoughts Reasoning Technique

This technique enables the model to simulate complex reasoning pathways similar to human thought processes. It generates multiple possible reasoning paths and selects the optimal path based on predefined criteria, enhancing the model’s ability to handle complex petro-technical queries.

### Potential Applications

The method may be used to perform customer service automation. More particularly, the method may efficiently handle complex, technical questions related to seismic interpretation, data analysis, and reservoir management. The method may also assist training and support systems. More particularly, the method may offer scalable training modules for technical staff in the oil and gas industry by using the fine-tuned SLM to simulate real-world technical scenarios. The method may also perform data processing and analysis. More particularly, the method may assist engineers and geoscientists by automating the interpretation of seismic data, reservoir models, and other technical datasets.

### Exemplary Method

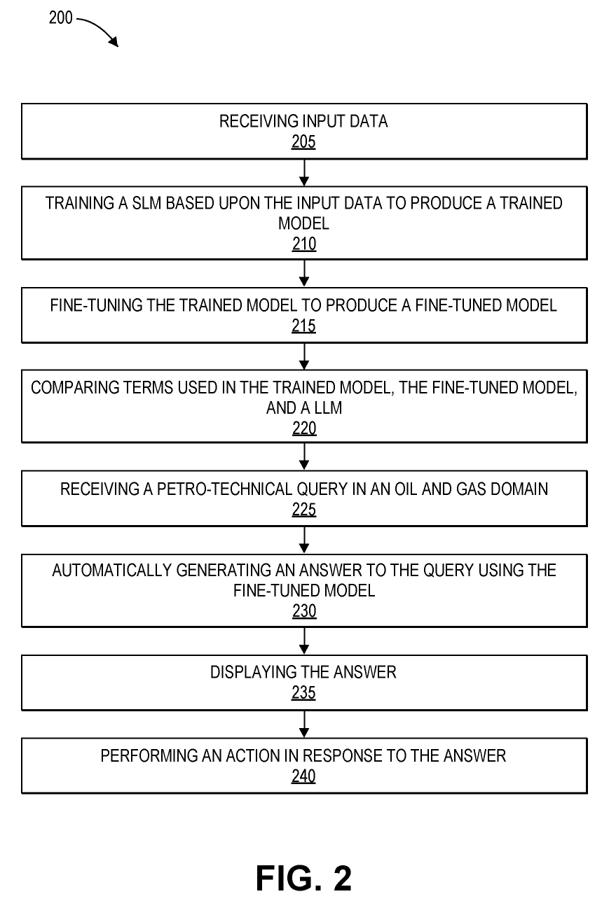

FIG. 2 illustrates a flowchart of a method 200 for automatically generating an answer to a petro-technical query in an oil and gas domain, according to an embodiment. An illustrative order of the method 200 is provided below; however, one or more portions of the method 200 may be performed in a different order, simultaneously, repeated, or omitted. At least a portion of the method 200 may be performed using a computing system.

The method 200 may include receiving input data, as at 205. The input data may include question-answer pairs. The question-answer pairs may be related to the oil and gas domain. For example, the question-answer pairs may be related to seismic interpretation, seismic sampling, seismic volume rendering and extraction, seismic quantitative interpretation, well correlation, facies modelling, petrophysical modelling, discrete fracture modelling, production forecast optimization, trajectory planning, geosteering forward modelling, or well log analysis.

The method 200 may also include training a small language model (SLM) based upon the input data to produce a trained model, as at 210. SLMs and LLMs differ mainly in scale, capability, cost, and deployment feasibility. The choice between them depends on task complexity, available resources, and performance. LLMs have billions to trillions of parameters and are trained on massive, diverse datasets. This enables high accuracy, exceptional generalization, and the ability to handle complex, multi-domain tasks without extensive fine-tuning. They excel in open-ended dialogue, creative content generation, code synthesis, and deep reasoning. However, they use large amounts of computational resources, have slower inference speeds, and incur high operational costs. SLMs, with millions to tens of millions of parameters, are trained on smaller or domain-specific datasets. They are faster, cost-effective, and deployable on edge devices like smartphones or IoT systems. While they may lack the broad generalization of LLMs, fine-tuning can make them highly accurate for specialized tasks such as customer support bots, keyword extraction, sentiment analysis, and real-time translation. They are ideal for low-latency, resource-constrained environments.

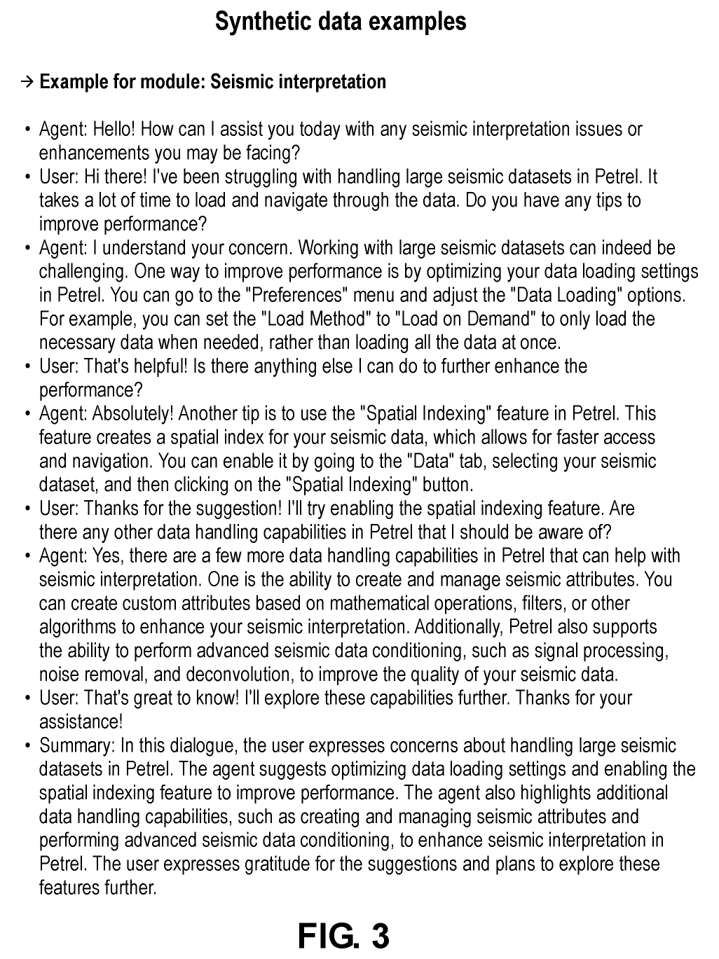

The SLM may be trained by creating prompts based upon the input data. In an example, one prompt may include a message from an artificial intelligence (AI) agent offering to assist with a seismic interpretation issue. In an embodiment, a tree of thoughts technique may be used in the prompts to improve reasoning capabilities of the SLM. The prompts may be used to create domain-specific datasets. The domain-specific datasets may be distilled from a LLM. The domain-specific datasets may include synthetic data that simulates real-world interactions in the oil and gas domain. In an example, the synthetic data may include (1) one or more questions about handling large seismic datasets in a software program (e.g., PETREL®), and (2) one or more answers from the AI agent. FIG. 3 illustrates synthetic data (e.g., questions and answers about handling large seismic datasets in the software program), according to an embodiment. The one or more answers are in response to the one or more questions. In this example, the one or more answers may suggest optimizing data loading settings, enabling spatial indexing, creating and managing seismic attributes, and/or performing advanced seismic conditioning to enhance seismic interpretation within the software program.

The method 200 may also include fine-tuning the trained model to produce a fine-tuned model, as at 215. Fine-tuning the trained model may include varying a subset of parameters of the trained model including. In an example, the parameters to vary may include adapter parameters added to the trained model, such as low-rank matrices (e.g., LoRA A and B matrices) coupled to one or more attention projection matrices (e.g., query, key, value, and/or output projections) and/or one or more feed-forward network projection matrices. The parameters to vary may also or instead include one or more task-specific output layer parameters (e.g., a response-generation head), embedding parameters, bias parameters, and/or layer-normalization scale/offset parameters.

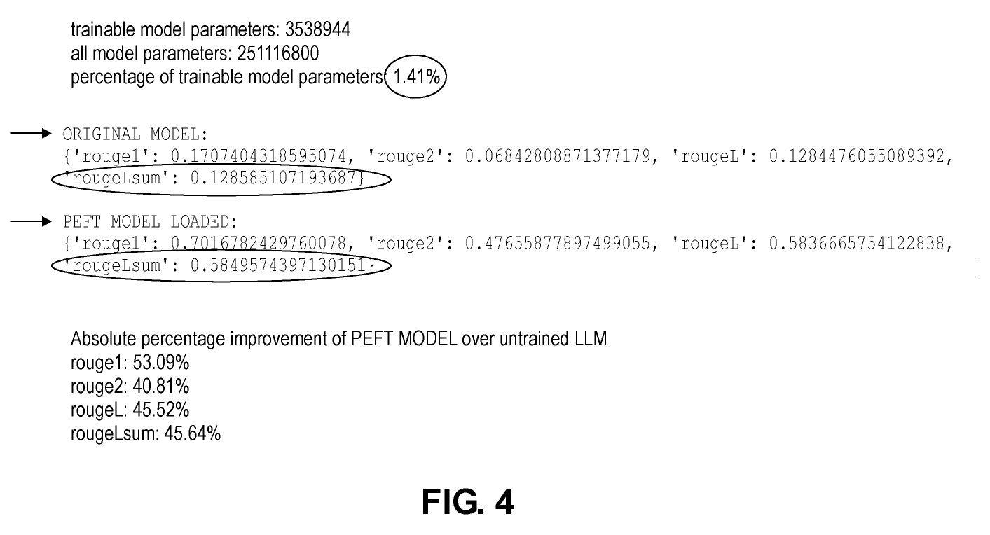

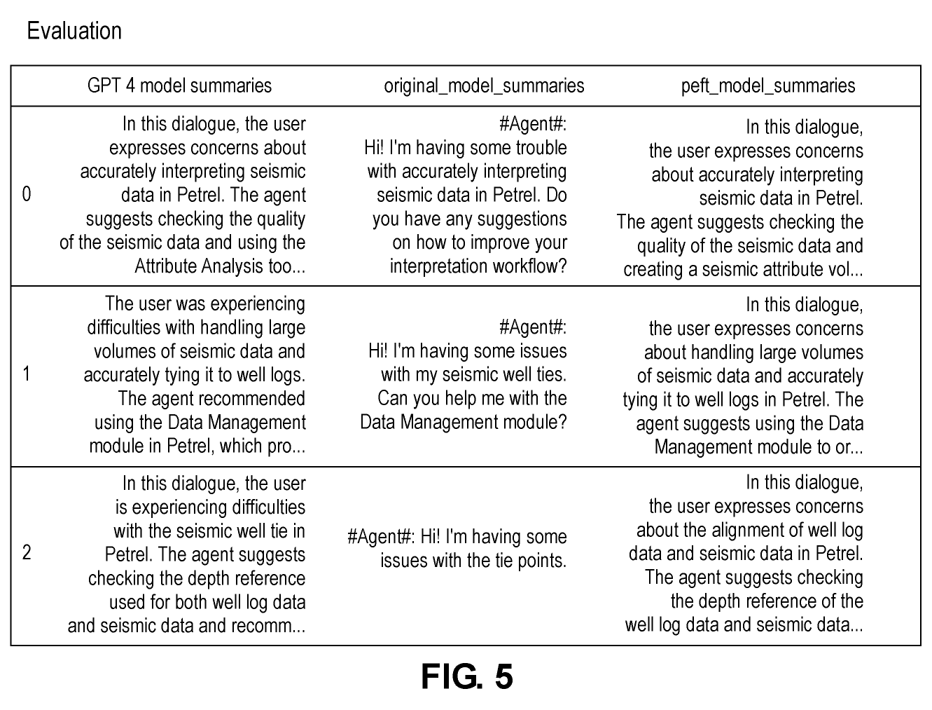

In an embodiment, the trained model may be fine-tuned using parameter efficient fine-tuning (PEFT). FIG. 4 illustrates results from fine-tuning the trained SLM using PEFT, according to an embodiment. In the example shown, fine-tuning the trained model using PEFT varies from about 0.5% to about 3% (e.g., 1.41%) of the parameters. In an example, fine-tuning the trained model using PEFT causes a first recall-oriented understudy for gisting evaluation (ROUGE) score to increase from a first range from about 0.08 to about 0.20 to a second range from about 0.40 to about 0.70. FIG. 5 illustrates summaries from (1) a LLM, (2) the trained SLM that has not been fine-tuned, and (3) the trained SLM that has been fine-tuned using PEFT, according to an embodiment. It may be seen that the summaries from the fine-tuned SLM more closely match the summaries from the LLM than the summaries from the non-fine-tuned SLM match the summaries from the LLM.

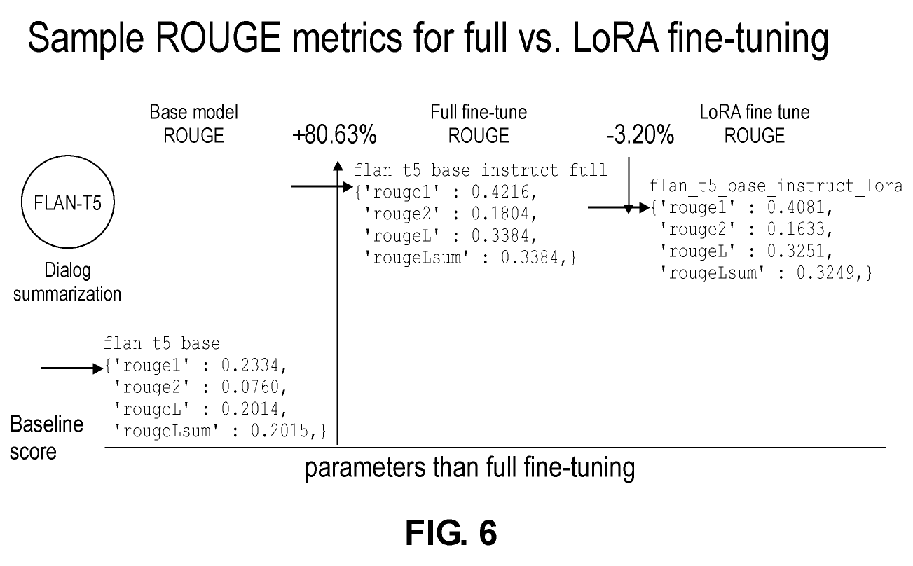

In another embodiment, the trained model may also or instead be fine-tuned using low-rank adaptation (LoRA). FIG. 6 illustrates results from fine-tuning the trained SLM using LoRA, according to an embodiment. In the example shown, fine-tuning the trained model using LoRA causes a second ROUGE score to increase from a first range from about 0.15 to about 0.25 to a second range from about 0.26 to about 0.40.

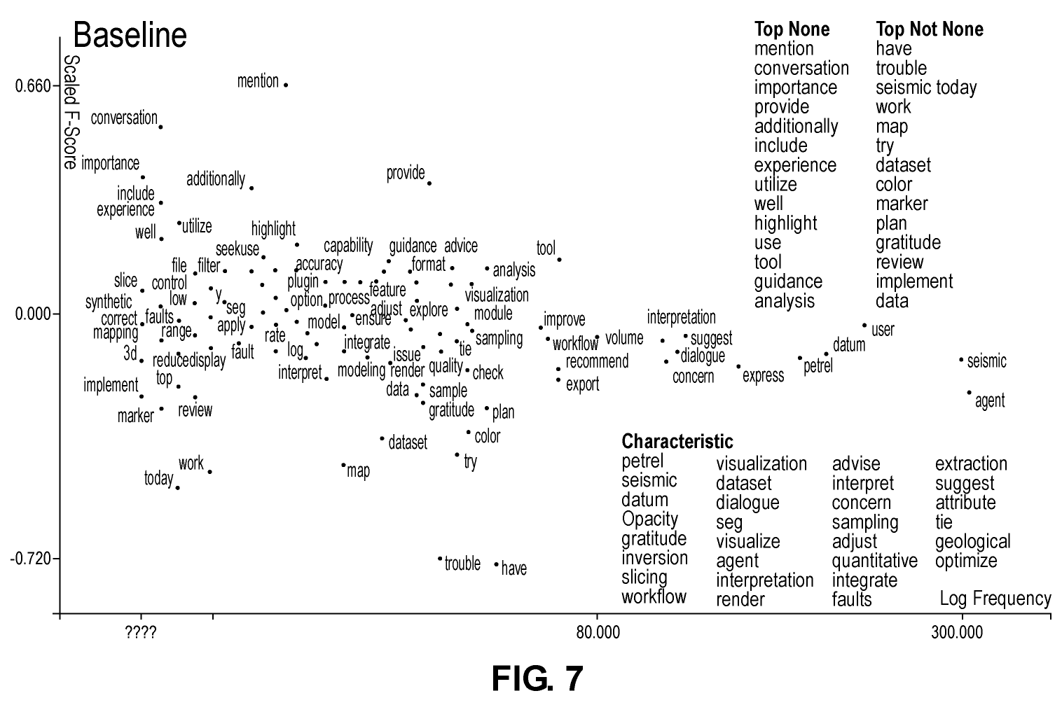

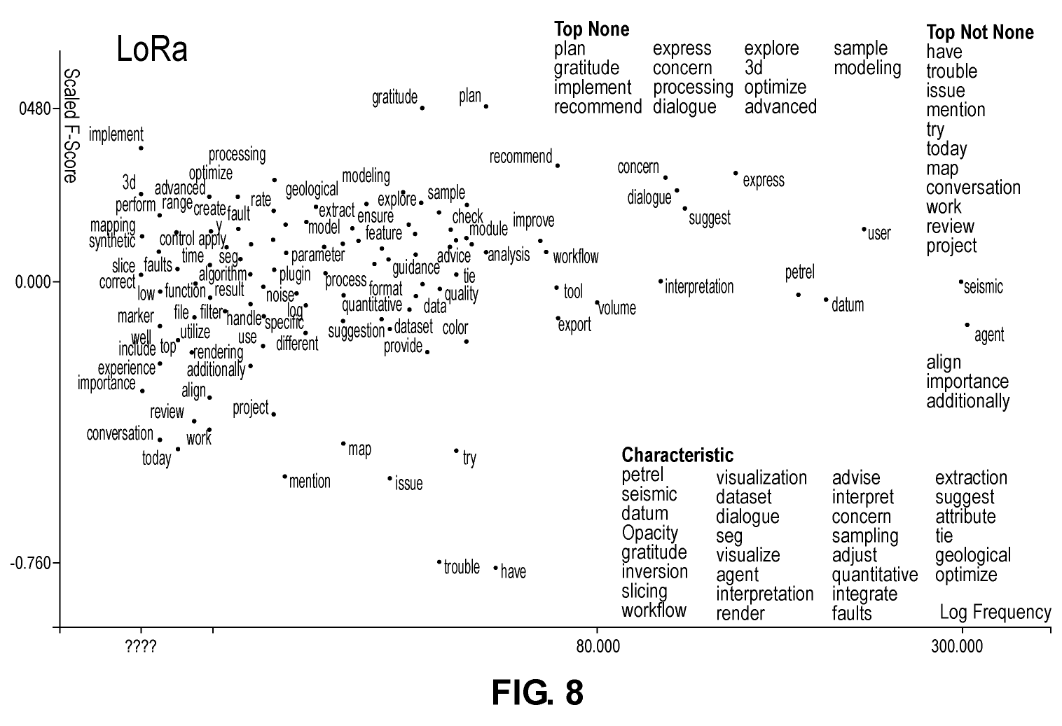

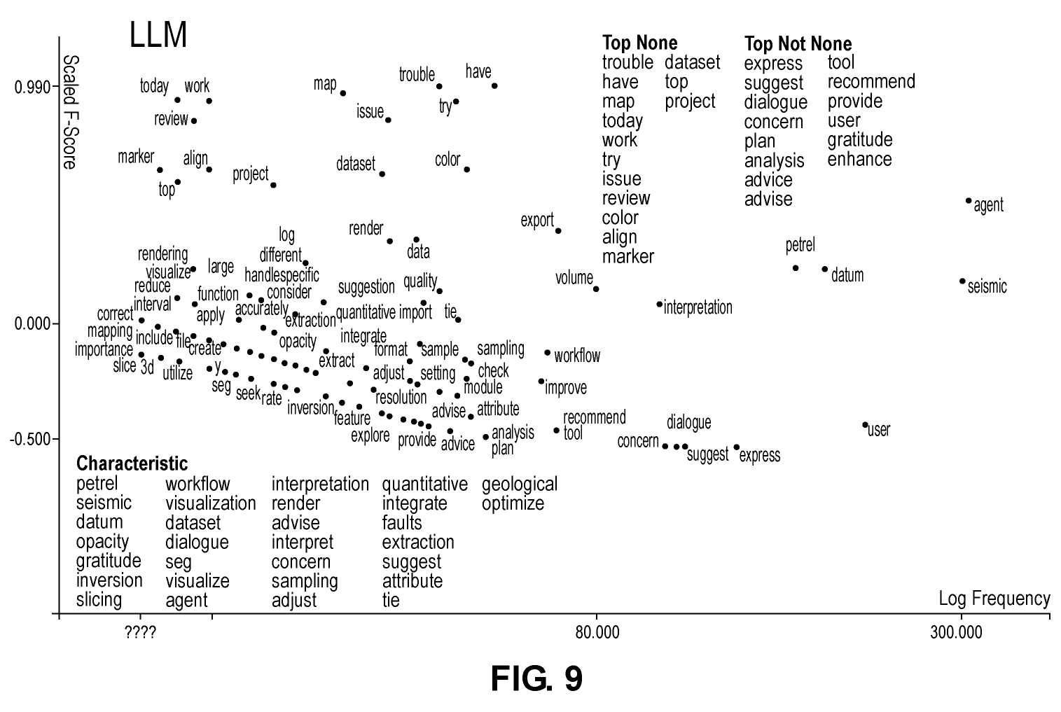

The method 200 may also include comparing terms used in the trained model, the fine-tuned model, and/or the LLM, as at 220. In an example, comparing the terms may include generating a graph for the trained model, the fine-tuned model, and/or the LLM. FIGS. 7-9 illustrate graphs corresponding to the trained (but non-fine-tuned) SLM (FIG. 7), the trained SLM that has been fine-tuned using LoRA (FIG. 8), and the LLM (FIG. 9), according to an embodiment. In the graphs, the X axis represents a (e.g., logarithmic) frequency of the terms, and the Y axis represents an F-score for the terms.

In an embodiment, the method 200 may also include re-fine-tuning the model (i.e., fine-tuning the model a subsequent time) in response to results of the comparison. Re-fine-tuning may include identifying one or more terms, phrases, or concepts associated with below-threshold scores (e.g., low F-scores), generating additional targeted domain-specific training samples emphasizing those terms (e.g., additional synthetic question-answer pairs), and re-running fine-tuning with the expanded dataset. In an example, re-fine-tuning further includes adjusting one or more fine-tuning hyperparameters (e.g., learning rate, number of epochs, and/or LoRA rank) and/or changing which layers are adapted (e.g., adapting additional attention and/or feed-forward layers), followed by re-evaluating the trained model and repeating until a target metric is achieved.

The method 200 may also include receiving a petro-technical query (e.g., from a user) in the oil and gas domain, as at 225. In an example, the query may include: “Based on the interpreted fault model and seismic attributes (e.g., coherence/curvature) in the target interval, a planned horizontal well is predicted to intersect a fault zone. What changes to the planned wellbore trajectory (e.g., landing point, azimuth, inclination, and/or dogleg severity) are recommended to remain within the reservoir target window while reducing fault-crossing risk?”

The method 200 may also include automatically generating an answer to the query using the fine-tuned model, as at 230. In an example, the answer may include (i) recommending verification of the suspected fault position and uncertainty (e.g., by checking multiple attributes and tying to available well markers), (ii) recommending a revised trajectory that shifts the lateral away from the fault corridor by a specified offset and/or adjusts azimuth to parallel the fault trend, (iii) recommending operational constraints to maintain a specified target window thickness (e.g., a maximum dogleg severity and a revised landing depth), and/or (iv) providing a set of actionable steps to implement the change (e.g., updated target coordinates, updated directional plan, and/or decision criteria for geosteering updates if the fault is approached).

The method 200 may also include displaying the answer, as at 235. In an embodiment, the graph(s) may also or instead be displayed.

The method 200 may also include performing an action in response to the answer, as at 240. The action may be or include generating and/or transmitting a signal (e.g., using a computing system) that recommends, instructs, or causes a physical action to occur (e.g., at a wellsite or oil and gas processing facility). The action may also or instead include performing the physical action at the wellsite. The physical action may include selecting where to drill a wellbore, drilling the wellbore, varying a weight and/or torque on a drill bit that is drilling the wellbore, varying a drilling trajectory of the wellbore, varying a concentration and/or flow rate of a fluid pumped into the wellbore, or the like. For example, in response to the question and answer at 225, 230, the SLM and/or AI agent may automatically recommend, instruct, or cause a modification to the drilling plan to occur, including transmitting a control or instruction signal that adjusts the planned wellbore trajectory (e.g., changing the target landing point and/or updating the downhole steering commands to vary inclination and/or azimuth) to reduce the likelihood of intersecting the fault zone while maintaining placement within the target reservoir interval.

### Exemplary Computing System

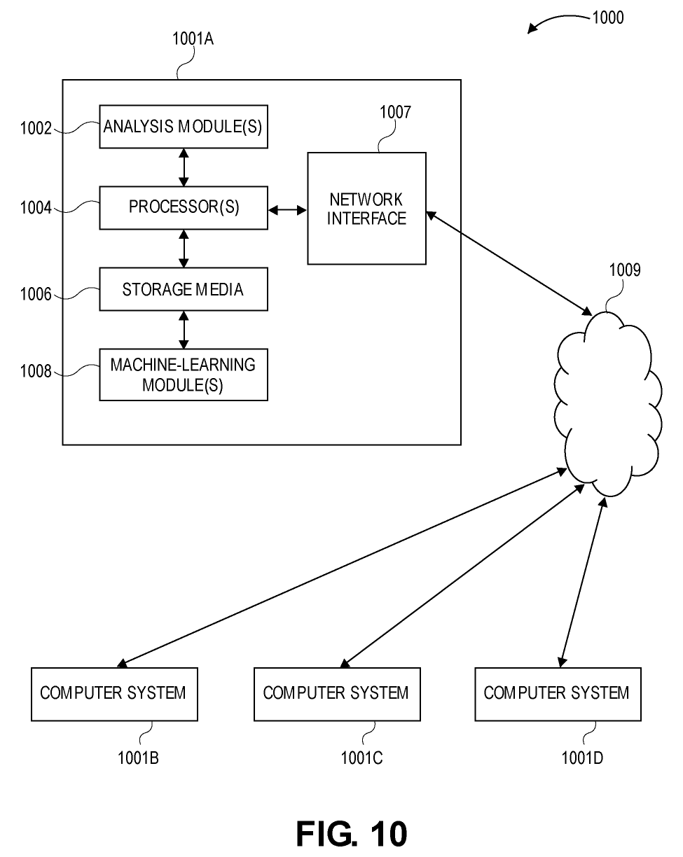

In some embodiments, the methods of the present disclosure may be executed by a computing system. FIG. 10 illustrates an example of such a computing system 1000, in accordance with some embodiments. The computing system 1000 may include a computer or computer system 1001A, which may be an individual computer system 1001A or an arrangement of distributed computer systems. The computer system 1001A includes one or more analysis modules 1002 that are configured to perform various tasks according to some embodiments, such as one or more methods disclosed herein. To perform these various tasks, the analysis module 1002 executes independently, or in coordination with, one or more processors 1004, which is (or are) connected to one or more storage media 1006. The processor(s) 1004 is (or are) also connected to a network interface 1007 to allow the computer system 1001A to communicate over a data network 1009 with one or more additional computer systems and/or computing systems, such as 1001B, 1001C, and/or 1001D (note that computer systems 1001B, 1001C and/or 1001D may or may not share the same architecture as computer system 1001A, and may be located in different physical locations, e.g., computer systems 1001A and 1001B may be located in a processing facility, while in communication with one or more computer systems such as 1001C and/or 1001D that are located in one or more data centers, and/or located in varying countries on different continents).

A processor may include a microprocessor, microcontroller, processor module or subsystem, programmable integrated circuit, programmable gate array, or another control or computing device.

The storage media 1006 may be implemented as one or more computer-readable or machine-readable storage media. Note that while in the example embodiment of FIG. 10 storage media 1006 is depicted as within computer system 1001A, in some embodiments, storage media 1006 may be distributed within and/or across multiple internal and/or external enclosures of computing system 1001A and/or additional computing systems. Storage media 1006 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY^{®} disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1000 contains one or more method execution module(s) 1008. In the example of computing system 1000, computer system 1001A includes the method execution module 1008. In some embodiments, a single method execution module may be used to perform some aspects of one or more embodiments of the methods disclosed herein. In other embodiments, a plurality of method execution modules may be used to perform some aspects of methods herein.

It should be appreciated that computing system 1000 is merely one example of a computing system, and that computing system 1000 may have more or fewer components than shown, may combine additional components not depicted in the example embodiment of

FIG. 10, and/or computing system 1000 may have a different configuration or arrangement of the components depicted in FIG. 10. The various components shown in FIG. 10 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1000, FIG. 10), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A method for automatically generating an answer to a petro-technical query in an oil and gas domain, the method comprising:
receiving input data including question-answer pairs related to the oil and gas domain;
training a small language model (SLM) based upon the input data to produce a trained model;
fine-tuning the trained model to produce a fine-tuned model;
receiving the petro-technical query in the oil and gas domain; and
automatically generating the answer to the petro-technical query using the fine-tuned model.

2. The method of claim 1, wherein the oil and gas domain is related to seismic interpretation, seismic sampling, seismic volume rendering and extraction, seismic quantitative interpretation, well correlation, facies modelling, petrophysical modelling, discrete fracture modelling, production forecast optimization, trajectory planning, geosteering forward modelling, or well log analysis.

3. The method of claim 1, wherein the SLM is trained by creating prompts based upon the input data.

4. The method of claim 3, wherein the prompts comprise an offer from an artificial intelligence (AI) agent to assist with a seismic interpretation issue.

5. The method of claim 3, wherein a tree of thoughts technique is used in the prompts to improve reasoning capabilities of the SLM.

6. The method of claim 3, wherein the prompts are used to create domain-specific datasets, and wherein the domain-specific datasets are distilled from a large language model (LLM).

7. The method of claim 6, wherein the domain-specific datasets comprise synthetic data that simulates real-world interactions in the oil and gas domain.

8. The method of claim 1, wherein the trained model is fine-tuned using parameter efficient fine-tuning (PEFT) and/or low-rank adaptation (LoRA).

9. The method of claim 1, further comprising displaying the answer.

10. The method of claim 1, further comprising performing an action in response to the answer.

11. A computing system, comprising:
one or more processors; and
a memory system comprising one or more non-transitory computer-readable media storing instructions that, when executed by at least one of the one or more processors, cause the computing system to perform operations, the operations comprising:
receiving input data, wherein the input data comprises question-answer pairs, and wherein the question-answer pairs are related to an oil and gas domain;
training a small language model (SLM) based upon the input data to produce a trained model, wherein:
the SLM is trained by creating prompts based upon the input data, wherein the prompts comprise an offer from an artificial intelligence (AI) agent to assist with an issue;
the prompts are used to create domain-specific datasets,
the domain-specific datasets are distilled from a large language model (LLM), and
the domain-specific datasets comprise synthetic data that simulates real-world interactions in the oil and gas domain;
fine-tuning the trained model to produce a fine-tuned model, wherein fine-tuning the trained model comprises varying a subset of parameters of the trained model, wherein the trained model is fine-tuned using:
parameter efficient fine-tuning (PEFT); and/or
low-rank adaptation (LoRA);
receiving a petro-technical query in the oil and gas domain; and
automatically generating an answer to the petro-technical query using the fine-tuned model.

12. The computing system of claim 11, wherein the synthetic data comprises:
one or more synthetic questions about handling large seismic datasets in a software program; and
one or more synthetic answers from the AI agent.

13. The computing system of claim 11, wherein the operations further comprise comparing terms used in the trained model, the fine-tuned model, and the LLM.

14. The computing system of claim 13, wherein comparing the terms comprises generating graphs for the trained model, the fine-tuned model, and the LLM.

15. The computing system of claim 14, wherein a first axis of each graph represents a frequency of the terms, and a second axis of each graph represents an F-score for the terms.

16. A non-transitory computer-readable medium storing instructions that, when executed by one or more processors of a computing system, cause the computing system to perform operations, the operations comprising:
receiving input data, wherein the input data comprises question-answer pairs, wherein the question-answer pairs are related to an oil and gas domain, and wherein the oil and gas domain is related to seismic interpretation, seismic sampling, seismic volume rendering and extraction, seismic quantitative interpretation, well correlation, facies modelling, petrophysical modelling, discrete fracture modelling, production forecast optimization, trajectory planning, geosteering forward modelling, or well log analysis;
training a small language model (SLM) based upon the input data to produce a trained model, wherein:
the SLM is trained by creating prompts based upon the input data, wherein the prompts comprise an offer from an artificial intelligence (AI) agent to assist with a seismic interpretation issue;
a tree of thoughts technique is used in the prompts to improve reasoning capabilities of the SLM,
the prompts are used to create domain-specific datasets,
the domain-specific datasets are distilled from a large language model (LLM),
the domain-specific datasets comprise synthetic data that simulates real-world interactions in the oil and gas domain, and
the synthetic data comprises:
one or more synthetic questions about handling large seismic datasets in a software program; and
one or more synthetic answers from the AI agent;
fine-tuning the trained model to produce a fine-tuned model, wherein fine-tuning the trained model comprises varying a subset of parameters of the trained model, wherein the trained model is fine-tuned using:
parameter efficient fine-tuning (PEFT); and
low-rank adaptation (LoRA);
comparing terms used in the trained model, the fine-tuned model, and the LLM, wherein comparing the terms comprises generating graphs for the trained model, the fine-tuned model, and the LLM with a first axis representing a frequency of the terms and a second axis representing an F-score for the terms;
receiving a petro-technical query in the oil and gas domain; and
automatically generating an answer to the petro-technical query using the fine-tuned model.

17. The non-transitory computer-readable medium of claim 16, wherein the one or more synthetic answers are in response to the one or more synthetic questions, and wherein the one or more synthetic answers suggest optimizing data loading settings, enabling spatial indexing, creating and managing seismic attributes, and/or performing advanced seismic conditioning to enhance seismic interpretation within the software program.

18. The non-transitory computer-readable medium of claim 16, wherein fine-tuning the trained model using PEFT varies from about 0.5% to about 3% of the parameters, and wherein fine-tuning the trained model using PEFT causes a recall-oriented understudy for gisting evaluation (ROUGE) score to increase from a first range from about 0.08 to about 0.20 to a second range from about 0.40 to about 0.70.

19. The non-transitory computer-readable medium of claim 16, wherein fine-tuning the trained model using LoRA causes a recall-oriented understudy for gisting evaluation (ROUGE) score to increase from a first range from about 0.15 to about 0.25 to a second range from about 0.26 to about 0.40.

20. The non-transitory computer-readable medium of claim 16, wherein the operations further comprise performing an action in response to the answer, wherein the action comprises generating or transmitting a signal that recommends, instructs, or causes a physical action to occur at a wellsite or oil and gas production facility, and wherein the action comprises drilling a wellbore, varying a weight and/or torque on a drill bit that is drilling the wellbore, varying a drilling trajectory of the wellbore, or varying a concentration and/or flow rate of a fluid pumped into the wellbore.
